(19) United States
(12) Patent Application Publication
(10) Pub. No.: US 2022/0134593 A1
(43) Pub. Date: May 5, 2022

(54) Chain Saw Tensioner and Chain Catcher

(71) Applicant: Black & Decker, Inc., New Britain, CT (US)

(72) Inventors: Nathan Greene, Baltimore, MD (US); Anthony Reth, Baltimore, MD (US); Ryan Wuerfl, Parkville, MD (US)

(21) Appl. No.: 17/090,220

(22) Filed: Nov. 5, 2020

(51) Int. Cl. B27B 17/14

(52) U.S. Cl. CPC B27B 17/14

(57) ABSTRACT

The present invention is directed to a chain saw having a chain tension knob to adjust the tension of a chain. The knob is rotated to move the chain bar to increase or decrease the tension on the chain depending on the direction of rotation. The knob is positioned at a forward portion of the chainsaw housing, below the chain bar. The knob acts as a chain catcher so that in case of chain breakage or derailment, it blocks the chain from swinging rearward toward the user and reduces the likelihood of serious injury.

### FIELD OF THE INVENTION

The present invention relates to portable chain saw equipment. Specifically, the present invention provides for a chain tension adjusting knob that also functions as a chain catcher. The dual function adjusting knob reduces the number of parts and simplifies the assembly process.

### BACKGROUND OF THE INVENTION

This section provides background information related to the present disclosure which is not necessarily prior art.

Typical portable chain saws include a means for adjusting the tension of the chain. This is most commonly accomplished by the front-back movement of a chain bar or guide bar. By increasing or decreasing the distance between the chain bar and a drive sprocket, the tension of the chain is effectively increased or decreased. In most cases, a knob or other user actuated device is attached to the chain bar through a lead screw, which the user rotates directly or via a gear set, thus moving the chain bar.

A chain catcher is used to curtail the rearward motion of the chain in the event of derailment or breakage. When one of these events occurs, the exposed chain is no longer retained by the chain bar and the loose chain falls and its rotational inertia swings it back towards the operator. The chain catcher provides a mechanical stop that reduces the rearward motion of the derailed chain.

Existing regulatory standards govern the use and placement of a chain catcher, requiring them to be placed under the saw chain as far to the front as practicable, and to extend laterally from the centerline of the chain bar at least 5 mm. Obviously, the chain catcher must also have sufficient mechanical strength to withstand the impact of the chain.

To provide sufficient mechanical strength, the chain catcher is often embodied as a metal plate bolted to the housing or via a larger plastic lug extending between the main body of the chain saw and the sprocket cover. The larger plastic lug is preferable when ease of assembly is prioritized, as it can be molded with the housing and so eliminates the need for an additional component. The downside to the plastic lug is that the increased size often impacts the ability of the saw to clear chips while cutting, resulting in decreased performance and user frustration.

### BRIEF SUMMARY OF THE INVENTION

This section provides a general summary of the invention and is not a comprehensive disclosure of its full scope or all of its features.

The present invention aims to provide a tension adjusting knob that serves the dual purpose of tensioning a chain and acting as a chain catcher, reducing the rearward motion of the chain in case of breakage or derailment.

Many chain saws have a tension adjusting knob that is capable of moving the chain bar to adjust the chain's tension. The present invention positions the knob at a front portion of the housing and below the chain bar so that it performs the additional function of a chain catcher.

Having the tension adjusting knob perform both functions eliminates the need for a separate chain catcher, allowing for more efficient chip ejection and simplifying the assembly of the chain saw. These benefits and others are achieved through reducing the number of parts.

In another aspect of the invention, the knob has a knurled outer surface to provide a better grip for the user. The knob may also include a slot, hex or other configuration to allow for the use of a corresponding tool to help turn the knob.

Further areas of applicability will become apparent from the description provided herein. The description and specific examples in this application are intended for purposes of illustration only and are not intended to limit the scope of the present disclosure.

### BRIEF DESCRIPTION OF THE INVENTION

Further features and advantages of the present invention will be better understood by reference to the following description, which is given by way of example and in association with the accompanying drawings, in which:

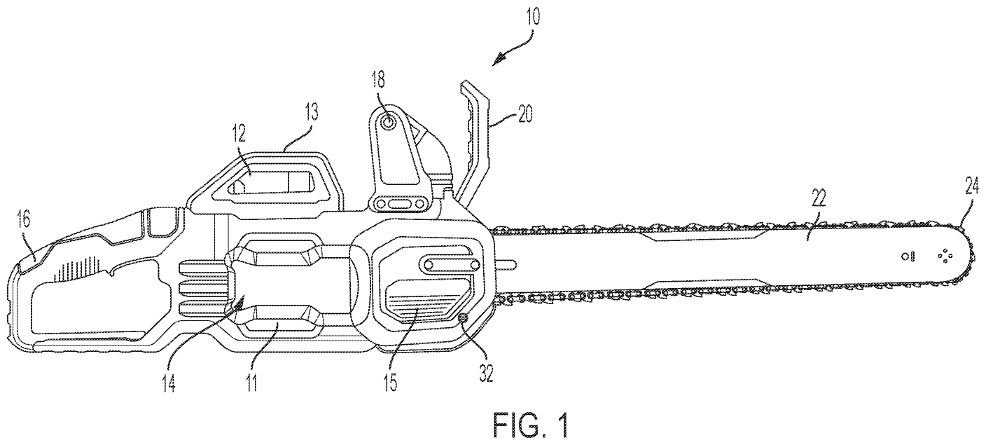

FIG. 1 is a right side view of a chain saw embodying the present invention;

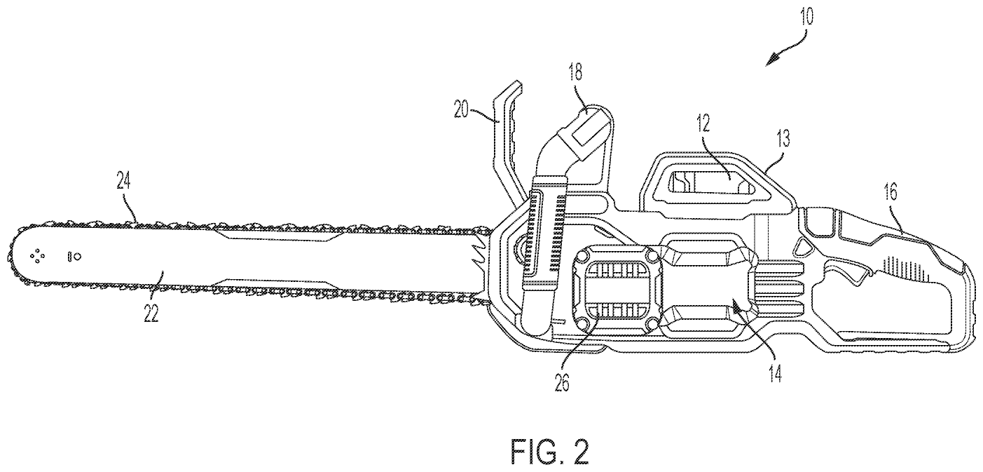

FIG. 2 is a left side view of a chain saw embodying the present invention;

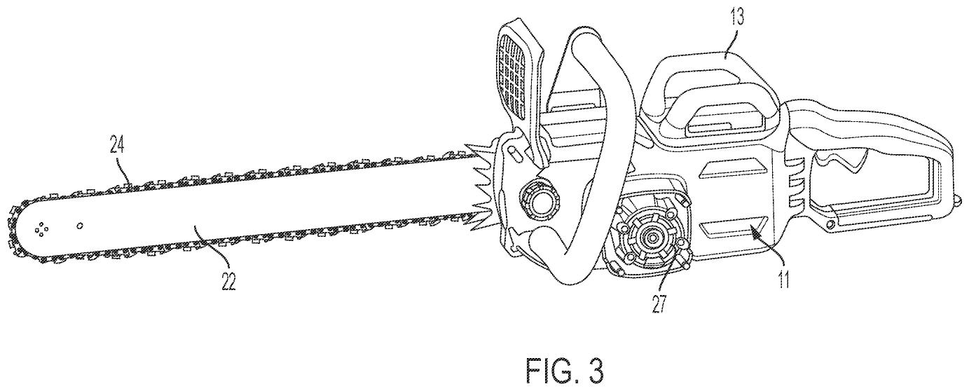

FIG. 3 is a left side perspective view of the chain saw with the battery removed;

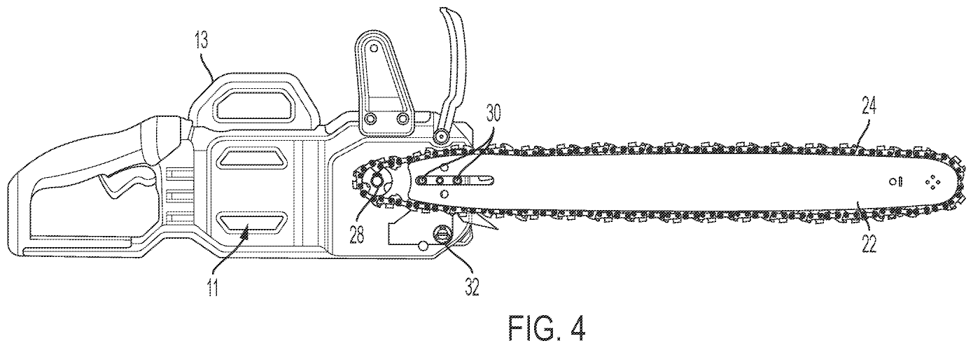

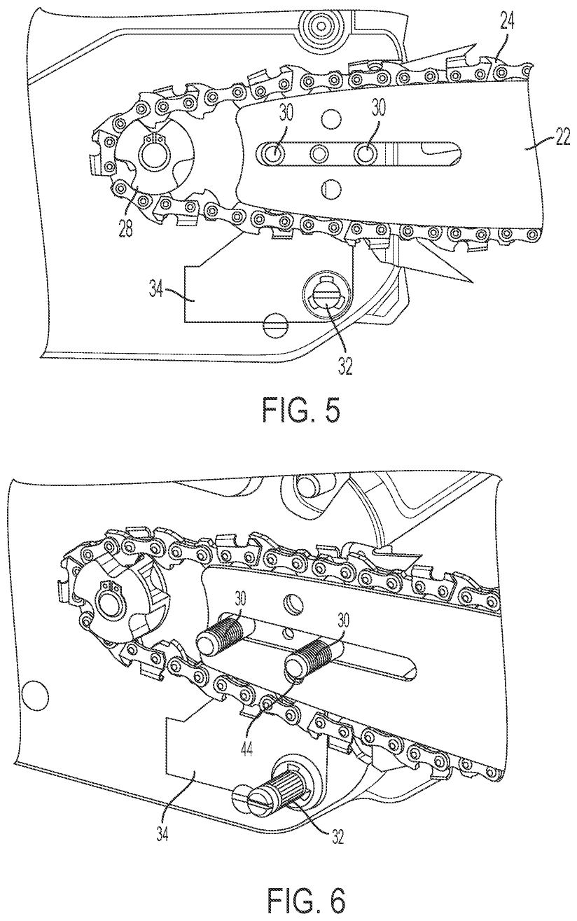

FIGS. 4-6 are detailed views of the right side of the chain saw showing the drive sprocket;

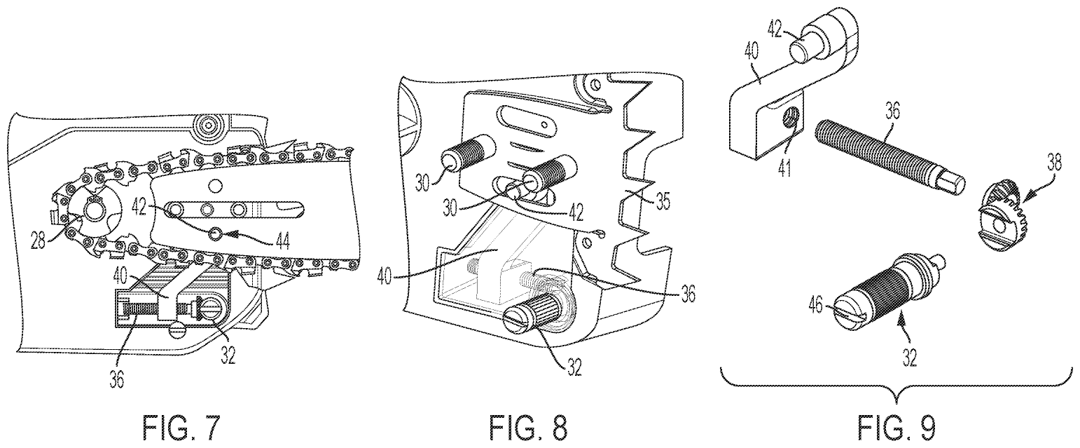

FIGS. 7 and 8 show the tension adjusting knob of the present invention;

FIG. 9 is an exploded view of the tension adjusting mechanism

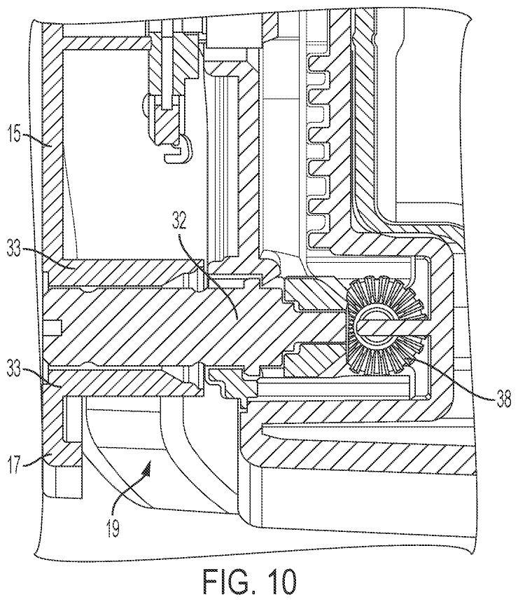

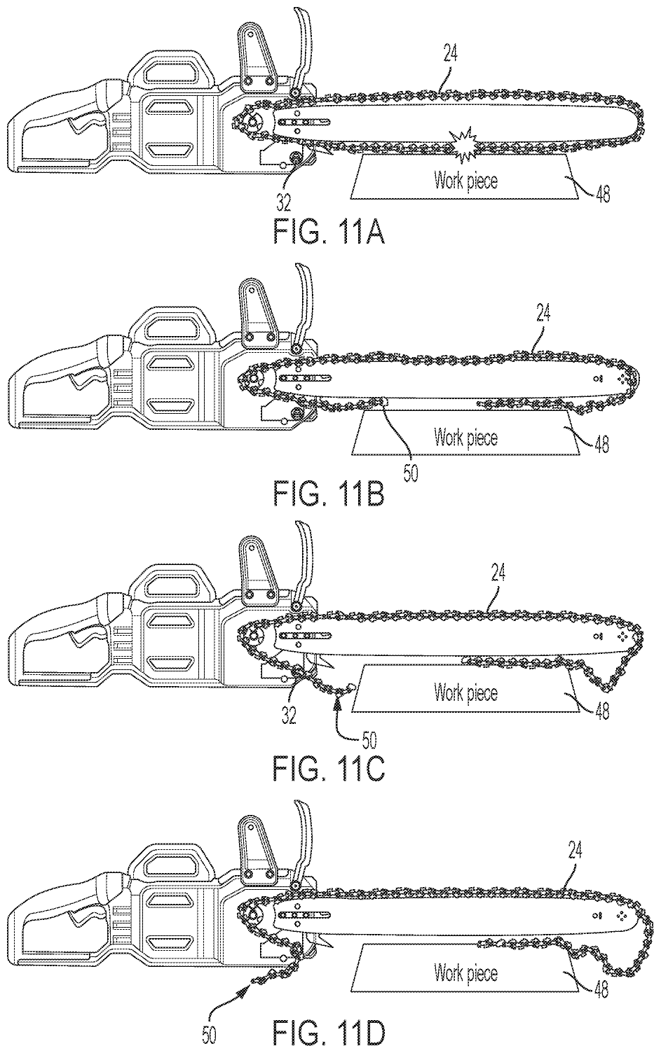

FIG. 10 is a sectional view of tension adjusting mechanism;

FIGS. 11A-11D show the various stages of a chain breakage; and

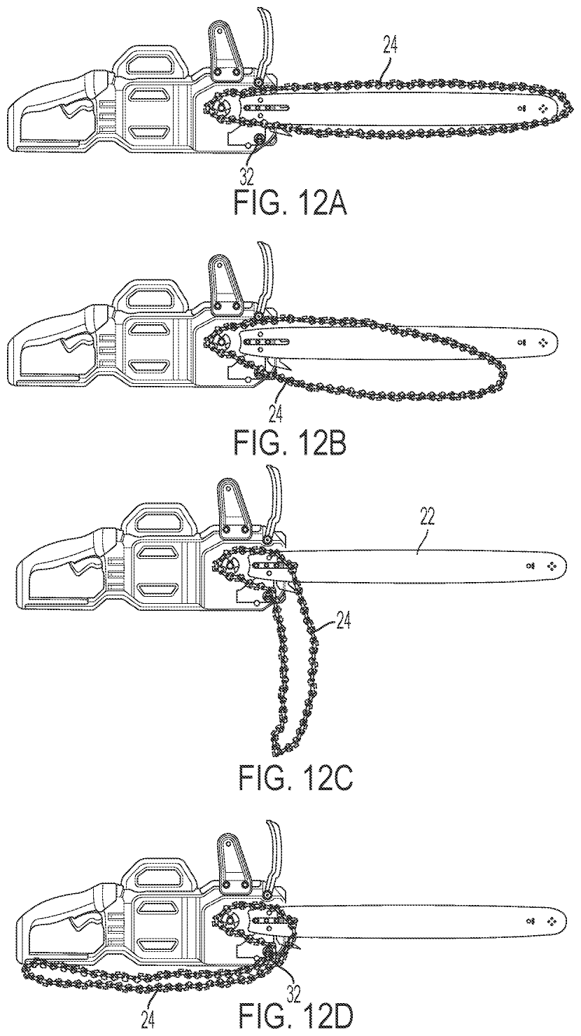

FIGS. 12A-12D show the various stages of a chain derailment.

### DETAILED DESCRIPTION OF THE INVENTION

Referring to FIGS. 1 and 2, a chain saw 10 of the present invention is shown. The chain saw 10 is electrically powered by a removable and rechargeable battery 12, that sits in a battery well 11 (see FIG. 3) in the housing 14. Although a battery powered chain saw is shown, the features of the present invention are applicable to any electrical, gas or other type of chain saw. The top portion of the battery well 11 includes a frame 13 that acts as roll cage to protect the battery 12. FIGS. 3 and 4 show the chain saw with the battery 12 removed to better illustrate the battery well 11 and frame 13.

At the rear of the housing 14 is an integrally formed main handle 16. Towards the front is an auxiliary handle 18 and a front guard 20. Protruding from the front of the housing is a chain bar 22 that holds a cutting chain 24. In normal use, an operator would simultaneously have one hand on the main handle 16 and the other hand on the auxiliary handle 18

FIG. 3 shows a left side of the chain saw, which is where a motor 27 is located. FIG. 2 shows a motor housing 26 enclosing the motor 27.

Referring now to FIGS. 4-6, a cover 15 is removed from the main housing 14, exposing a sprocket 28 underneath. The sprocket 28 is rotatably driven by the motor 27 and engages with the chain 24 to move it around the chain bar 22. The chain bar 22 is supported within the housing 14 by bolts 30. The cover 15 is screwed onto the bolts 30 and secures the chain bar 22 between it and the housing 14.

Below the chain bar 22 at a front portion of the housing 14 is a chain tensioning adjustment knob 32. The knob 32 is capable of moving the chain bar 22 forward or backward to tighten or loosen the chain 24, respectively, as explained below.

Referring to FIG. 7, a housing plate 34 is removed to show the parts involved in the operation of the tensioning knob 32. FIG. 8 is similar to FIG. 7, but chain bar 22 is removed for greater clarity. Removal of the chain bar 22 also highlights the presence of the bucking spikes 35. The bucking spikes 35 have a series of teeth that assist in securing a workpiece in place while the chain saw is operating and are attached to bolts 30.

FIG. 9 shows an exploded view of the parts involved in the chain tensioning operation. The knob 32 is connected to a threaded screw 36 at a first end via a pair of bevel gears 38. The opposite end of the screw 36 is rotatably threaded inside opening 41 of tension trolley 40, so that as the screw is rotated, the trolley 40 moves along its length. The other end of the trolley 40 has a pin 42 that's secured in an opening 44 in the chain bar 22.

In operation, when the tensioning knob 32 is rotated, the bevel gears 38 rotate the screw 36. As the screw 36 is rotated, the trolley 40 then moves along its length depending on the direction of the screw's rotation. Because the trolley 40 is secured to the chain bar 22, the chain bar moves further or closer to the sprocket 28, thereby increasing or decreasing the tension on the chain 24. The use of bevel gears 38 allows for the axis of rotation of the screw 36 to be at a different angle from the axis of rotation of the tension adjusting knob 32. This allows for optimizing the knob's 32 orientation to allow for easier user operation.

The tension adjusting knob 32 projects from a side surface of the housing 14, outside of the closed loop of chain 24. The tension adjusting knob 32 is disposed below the chain 24, and as far forward as is practicable.

In the preferred embodiment, the tension adjusting knob 32 extends through an opening in the housing plate 34. The cover 15 is placed over the knob 32, with the cover 15 having a shroud 33 that surrounds the knob 32 to provide additional mechanical strength (see FIG. 10). The cover also allows for the tension adjusting knob 32 to stay clean during any tensioning operation, so the operator can have a more reliable engagement with the knob 32. The cover 15 has a lip 17 that forms a groove 19 between it and the housing 14. Although inclusion of the shroud 33 is preferred, it can be removed to maximize the efficiency of chip ejection if desired.

The knob's 32 outer surface can be knurled or ribbed to provide a better gripping surface for rotation. Additionally, a slot 46 is included on an end face of the knob 32 which allows for a screwdriver or other tool to be used to turn the knob 32. Although a slot is shown, it should be understood that a hex, star, or any other shape to allow for the use of a corresponding tool can be used.

One of the benefits of using the knob 32 is that it serves the additional function as a chain catcher if the chain 24 were to break or derail from the chain bar 22.

FIGS. 11A-11C show the knob 32 functioning as a chain catcher when the chain 24 breaks while cutting a workpiece 48. FIG. 11A shows the chain just prior to breakage. FIG. 11B shows the chain breaking, at which time the chain ends separate and a proximate chain end 50 is propelled back towards the user. Without a chain catcher, the chain 24 could strike the user, causing serious injury. FIGS. 11C and 11D show the knob 32 blocking the chain 24 and stopping it from fully swinging backward. Although the knob 32 may not completely stop the chain, the knob 32 reduces the length of chain that's free to swing and greatly reduces the risk of injury.

The forward placement of the knob 32, and its location outside the perimeter of the chain bar 22 are critical to its operation, allowing it to impede any broken or derailed chain 24. If the knob 32 were placed insufficiently forward, the chain 24 might be blocked too late and the risk of injury to the user would increase. Furthermore, the knob 32 must lie outside the perimeter of the chain bar and should extend away from the housing a sufficient length to ensure that it blocks the chain 24 upon its separation from the chain bar 22. In a preferred embodiment, the knob extends at least 5 mm away from the housing.

The present invention also provides a groove 19 (see FIG. 10) that helps control the chain 24 from wildly swinging by trapping it between the cover 15 and housing 14. The groove 19 should be aligned generally in the same plane as the chain 24, so that if the chain 24 disengages from the chain bar, it would swing rearwardly into the groove 19, whose walls would keep it contained.

Similarly, FIGS. 12A-12D show the chain 24 derailing from the chain bar 22. FIG. 12A shows the chain 24 just prior to derailment, and FIG. 12B shows the chain just after it derails. Again, the knob 32 catches the derailed chain 24, and like with the chain breakage situation, it reduces the length of chain that's free to swing backward and reduces the likelihood of injury.

Normally, the chain bar 22 is not positioned along the center of the housing, but rather offset to one side of the centerline. In the present drawings, the chain bar is shown on a right side of the housing, but it could be on the left side and still fall within the scope of the invention. Because the chain bar 22 is offset, any breakage or derailment in the chain would come from the same side of the housing, and so the chain tension knob 32 must be on the same side of the housing as the chain bar 22.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure

1. A chainsaw having a chain tensioning system comprising:
a housing enclosing a motor, the housing having a front surface and a side surface;
a chain bar extending from the front surface of said housing, the chain bar defining a plane;
a chain secured around the chain bar;
the motor driving a sprocket, the sprocket engaging the chain to drive it around the chain bar;
a chain tensioning actuator capable of moving the chain bar to tension the chain, the actuator positioned on the side surface of the housing, the actuator lying in the plane of the chain bar and below the chain bar adjacent the front surface, and the actuator extending from the side surface in a direction perpendicular to the plane of the chain bar;
a cover that supports the actuator and secures the chain bar to the housing; and
wherein the cover and the housing form a groove, the groove extending downward to at least the bottom of the cover and in the same plane as the chain bar, the groove adapted to funnel the chain to the adapter if the chain becomes disengaged from the chain bar.

2. The chainsaw of claim 1, wherein the actuator is generally cylinder shaped with a knurled outer surface.

3. The chainsaw of claim 2, wherein the actuator has a slot on an end face capable of accepting a tool for turning the actuator.

4. The chainsaw of claim 1, wherein rotation of the actuator moves the chain bar.

5. The chainsaw of claim 1, wherein the actuator extends across the groove.

6. (canceled)

7. (canceled)

8. A method of adjusting the tension of a chain on a chainsaw comprising the steps:
providing a chainsaw having a housing, a chain bar extending from a front surface of the housing, a motor for driving a chain around the chain bar and a chain tensioning actuator, a cover having a shroud that supports the actuator and secures the chain bar to the housing, wherein the cover and the housing form a groove below the actuator;
wherein the actuator is positioned in a side surface of said housing, adjacent the front surface and below the chain bar, the actuator extending outwardly in a direction perpendicular to the chain bar;
turning the actuator to move the chain bar to adjust the tension on the chain;
wherein upon breakage or derailment of the chain from the chain bar, the chain enters the groove and contacts the actuator which acts as a stop to limit the chain from moving rearward toward a user.

9. The method of adjusting the tension of a chain on a chainsaw as claimed in claim 8, wherein the actuator is cylinder shaped and has a knurled outer surface.

10. The method of adjusting the tension of a chain on a chainsaw as claimed in claim 9, wherein the actuator has a slot on an end face for accepting a tool for turning the actuator.

11. (canceled)

12. The chainsaw of claim 1, wherein the actuator is positioned forward of the sprocket.

13. The method of adjusting the tension of a chain on a chainsaw as claimed in claim 8, wherein the motor drives a sprocket to move the chain bar, and the actuator is positioned forward of the sprocket.
